(19) United States
(12) Patent Application Publication
(10) Pub. No.: US 2016/0220857 A1
(43) Pub. Date: Aug. 4, 2016

(54) LIFELINE FOR A FALL PROTECTION SYSTEM

(71) Applicant: Werner Co., Greenville, PA (US)

(72) Inventors: CODY RAPPOPORT, GREENVILLE, PA (US); ERIC MILLER, CARMEL, IN (US)

(21) Appl. No.: 14/609,987

(22) Filed: Jan. 30, 2015

(51) Int. Cl. A62B 35/00

(52) U.S. Cl. CPC A62B 35/0093; A62B 35/0043

(57) ABSTRACT

A lifeline for use with a fall protection system, the lifeline including a first edge portion disposed at a first edge of the lifeline and including outer edge threads forming an exterior portion of the first edge portion and inner edge threads forming an interior portion of the first edge portion, a second edge portion disposed at a second edge of the lifeline and including outer edge threads forming an exterior portion of the second edge portion and inner edge threads forming an interior portion of the second edge portion, and a central portion spanning between the first edge portion and the second edge portion, the central portion including central threads. The outer edge threads have a first color and the inner edge threads have a second color different than the first color.

### CROSS-REFERENCE TO RELATED APPLICATIONS

This patent application claims the priority benefit under 35 U.S.C. §119(e) of U.S. Provisional Application No. 61/935,438 filed on Feb. 4, 2014, and entitled, “LIFELINE FOR A FALL PROTECTION SYSTEM,” the contents of which are hereby incorporated herein by reference.

### BACKGROUND OF THE INVENTION

1. Field of the Invention

The disclosed concept pertains to a fall protection systems used in conjunction with a lifeline, and, in particular, to the lifeline employed in the fall protection system.

2. Description of the Related Art

Workers working in elevated positions, such as on roofs or construction, typically utilize some type of safety protection system to protect again falls. One such known hill protection system employs webbing, rope or cable, also commonly known as a lifeline, and incorporates a retraction device such that the lifeline remains taut. This system is connected to a safety harness worn by the worker and also an anchor point. The retraction device is structured such that under normal conditions the lifeline is able to move freely in or out with the worker as he or she works, However, if the worker falls, the retraction device locks, stopping the lifeline from further extending thereby stopping the worker's fall.

Lifelines are commonly made from a woven polymer or a steel cable. Over time, a lifeline can become worn and begin to develop tears. The tears commonly begin as tears in the outer material of the lifeline. Continued use of the lifeline can result in the tears progressing and possibly reaching the point where the lifeline breaks. Obviously, this is a significant safety concern. It is important to identify tears in lifelines as early as possible so that any lifelines beginning to develop tears can be replaced. However, it can be difficult and time consuming to visually identify the beginning stages of a tear in a lifeline.

There is thus room for improvement in the fields of lifelines for fall protection systems and fall protection systems.

### SUMMARY OF THE INVENTION

These needs and others are met by embodiments of the disclosed concept, which provides a lifeline for use with a fall protection system, the lifeline including outer and inner edge threads that have different colors.

In one embodiment, a lifeline for use with a fall protection system comprises: a first edge portion disposed at a first edge of the lifeline and including outer edge threads forming an exterior portion of the first edge portion and inner edge threads forming an interior portion of the first edge portion; a second edge portion disposed at a second edge of the lifeline and including outer edge threads forming an exterior portion of the second edge portion and inner edge threads forming an interior portion of the second edge portion; and a central portion spanning between the first edge portion and the second edge portion, the central portion including central threads, wherein the outer edge threads have a first color and the inner edge threads have a second color different than the first color.

In another embodiment, a fall protection system comprises: a lifeline including: a first edge portion disposed at a first edge of the lifeline and including outer edge threads forming an exterior portion of the first edge portion and inner edge threads forming an interior portion of the first edge portion, a second edge portion disposed at a second edge of the lifeline and including outer edge threads forming an exterior portion of the second edge portion and inner edge threads forming an interior portion of the second edge portion, and a central portion spanning between the first edge portion and the second edge portion, the central portion including central threads, wherein the outer edge threads have a first color and the inner edge threads have a second color different than the first color, and a retraction device coupled to a first end of the lifeline; and an attachment device coupled to a second end of the lifeline, the attachment device being structured to couple to an article worn by a user of the fall protection system.

These and other objects, features, and characteristics of the disclosed concept, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

FIG. 1 is a view of a fall protection system in accordance with an embodiment of the disclosed concept;

FIG. 2A is a front view of a lifeline that does not include a tear in accordance with an embodiment of the disclosed concept;

FIG. 2B is a cross-sectional view of the lifeline of FIG. 2A; and

FIG. 3 is a front view of the lifeline of FIG. 2A including a partially torn outer edge.

### DETAILED DESCRIPTION OF EXEMPLARY EMBODIMENTS

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “'number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

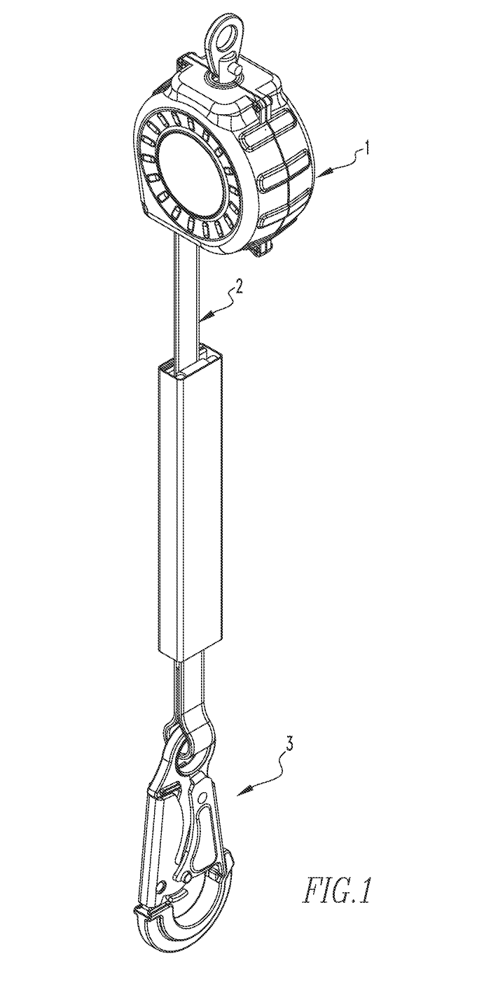

FIG. 1 is a view of a retraction device 1 coupled to a lifeline 2 (e.g., without limitation, a cable) forming part of a fall protection system according to an exemplary embodiment of the disclosed concept. The retraction device 1 includes a cable grab assembly structured to grip the lifeline 2 in the event of a fall. One end of the lifeline 2 is coupled to the retraction device 1 and the other end of the lifeline 2 is coupled to an attachment device 3. The attachment device 3 is structured to couple to an article such as a belt or harness worn by a user of the fail protection system.

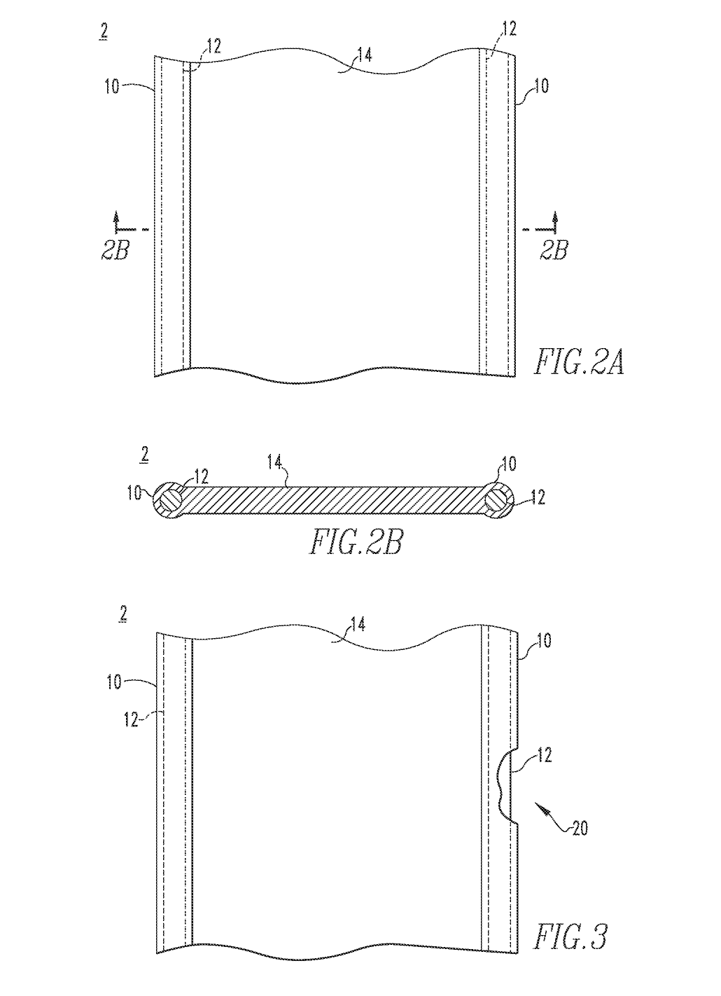

Since it is vital that the lifeline 2 must be able to support the weight of the user of the fall protection system without breaking, it is important to regularly inspect the lifeline 2 to verify that it is in good condition. Over time, the lifeline 2 can become worn and begin to develop tears. It is important to identify such tears early so that the lifeline 2 may be replaced. The lifeline 2 will be described in more detail hereinafter with reference to FIGS. 2A and 2B.

FIG. 2A is a front view of the lifeline 2 and FIG. 2B is a cross-sectional view of the lifeline 2 through section line 2B, shown in FIG. 2A. The lifeline 2 includes outer edge threads 10, inner edge threads 12, and central threads 14.

The outer and inner edge threads 10,12 are disposed at first and second opposite edge portions of the lifeline 2 and together form the edges of the lifeline 2. The outer edge threads 10 form the exterior of the edge portions and the inner edge threads 12 form the interior of the edge portions. The central threads 14 are disposed in a central portion of the lifeline 2 that spans between the first edge portion and the second edge portion.

In the exemplary embodiment, the outer edge threads 10, inner edge threads 12, and central threads 14 are woven polymers such as, for example and without limitation, ultra high molecular weight polyethylene (UHMW polyethylene), liquid crystal polymer, polyester or nylon. However, it will be appreciated by those having ordinary skill in the art that other suitable materials may be used for the outer edge threads 10, inner edge threads 12, and central threads 14 without departing from the scope of the disclosed concept.

The outer edge threads 10 and the inner edge threads 12 have different colors. While any different colors may be used for the outer edge threads 10 and the inner edge threads, it is preferable to select contrasting different colors for the outer edge threads 10 and the inner edge threads 12. For example and without limitation, using a dark colored material (e.g., black, dark blue, dark green, etc.) for the one of the outer and inner edge threads 10,12 and a light colored material (e.g., white, pink, yellow, orange, etc.) for the other of the outer and inner edge threads 10,12, or vice versa, causes a color contrast between the two threads. In some example embodiments of the disclosed concept, the outer edge threads 10 are black and the inner edge threads 12 are red.

The lifeline 2 is in an untorn state in FIGS. 2A and 2B. In the untorn state, the outer edge threads 10 surround the inner edge threads 12 so that the inner edge threads 12 are not visible to an observer of the lifeline 2. However, when the lifeline 2 wears, tears generally first develop in the most exterior parts of the lifeline 2. That is, the outer edge threads 10 on the outer surface of the lifeline 2 will generally begin to tear first, thus exposing the inner edge threads 12. The inner edge threads 12 being visible due to tears in the outer edge threads 10 can serve as an indication that the lifeline 2 may be starting to wear out and will need to be replaced.

Referring to FIG. 3, the lifeline 2 is shown in a partially torn state. The partially torn state includes a tear area 20 in which the outer edge thread 10 is partially torn. The inner edge thread 12 is exposed in the tear area 20, and thus is visible to an observer of the lifeline 2.

By using different colors for the outer and inner threads 10,12, it is easier to identify when the outer thread 10 is torn and the inner thread 12 is visible. For example, lifelines whose edges are comprised of a single color may require a close inspection to determine whether the lifeline is beginning to show signs of wear, whereas a quick visual inspection of the partially for lifeline 2 of FIG. 3 reveals that the inner edge threads 12 are visible, which can be used as a sign that the lifeline 2 is wearing out and will need to be replaced. In some example embodiments of the disclosed concept, contrasting colors are selected for the outer edge threads 10 and the inner edge threads 12, which results in an observer more easily noticing that the inner edge threads 12 are visible, and thus being able to determine that the lifeline 2 may be partially torn. In some example embodiments of the disclosed concept, the outer edge threads 10 are black and the inner edge threads 12 are red, which also results in an observer being able to easily identify that the inner edge threads 12 are exposed, thus indicating that the lifeline 2 may be partially torn.

While contrasting and black and red colors as being used for the outer edge threads 10 and the inner edge threads 12, it will be appreciated by those having ordinary skill in the art that any suitable different colors may be selected for the outer and inner edge threads 10,12 without departing from the scope of the disclosed concept.

Although the disclosed lifeline 2 is made of woven polymer, it will be appreciated by those having ordinary skill in the art that the disclosed concept may be adapted for use with lifelines made of different materials. For example and without limitation, it is contemplated that the disclosed concept may be adapted for use with metallic lifelines such as steel cables.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the invention has been described in detail for the purpose of illustration based on who is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A lifeline for use with a fall protection system, the lifeline comprising:
a first edge portion disposed at a first edge of the lifeline and including outer edge threads forming an exterior portion of the first edge portion and inner edge threads forming an interior portion of the first edge portion;
a second edge portion disposed at a second edge of the lifeline and including outer edge threads forming an exterior portion of the second edge portion and inner edge threads forming an interior portion of the second edge portion; and
a central portion spanning between the first edge portion and the second edge portion, the central portion including central threads,
wherein the outer edge threads have a first color and the inner edge threads have a second color different than the first color.

2. The lifeline of claim 1, wherein at least one of the outer edge threads, the inner edge threads, and the central threads are composed of woven polymers.

3. The lifeline of claim 1, wherein at least one of the outer edge threads, the inner edge threads, and the central threads are composed of ultra high molecular weight polyethylene, liquid crystal polymer, nylon or polyester.

4. The lifeline of claim 1, wherein the first color and the second color contrast with each other.

5. The lifeline of claim 1, wherein one of the first and second colors is a color selected from black, dark blue, and dark green, and
wherein the other of the first and second colors is a color selected from white, pink, yellow, orange, and red.

6. The lifeline of claim 1, wherein the first color is black and the second color is red.

7. The lifeline of claim 1, wherein when the first and second edge portions are in an untorn state, the outer threads are visible and the inner threads are not visible to an observer, and
wherein when the first or second edge portions are in a partially torn or torn state, the outer threads are visible and at least a portion of the inner threads are visible to the observer.

8. A fall protection system comprising:
a. lifeline including:
a first edge portion disposed at a first edge of the lifeline and including outer edge threads forming an exterior portion of the first edge portion and inner edge threads forming an interior portion of the first edge portion,
a second edge portion disposed at a second edge of the lifeline and including outer edge threads forming an exterior portion of the second edge portion and inner edge threads forming an interior portion of the second edge portion, and
a central portion spanning between the first edge portion and the second edge portion, the central portion including central threads,
wherein the outer edge threads have a first color and the inner edge threads have a second color different than the first color, and
a retraction device coupled to a first end of the lifeline; and
an attachment device coupled to a second end of the lifeline, the attachment device being structured to couple to an article worn by a user of the fall protection system.

9. The fall protection system of claim 8, wherein at least one of the outer edge threads, the inner edge threads, and the central threads are composed of woven polymers.

10. The fall protection system of claim 8, wherein at least one of the outer edge threads, the inner edge threads, and the central threads are composed of ultra high molecular weight polyethylene, liquid crystal polymer, nylon or polyester.

11. The fall protection system of claim 8, wherein the first color and the second color contrast with each other.

12. The fall protection system of claim 8, wherein one of the first and second colors is a color selected from black, dark blue, and dark green, and
wherein the other of the first and second colors is a color selected from white, pink, yellow, orange, and red.

13. The fall protection system of claim 8, wherein the first color is black and the second color is red.

14. The fall protection system of claim 8, wherein when the first and second edge portions are in an untorn state, the outer threads are visible and the inner threads are not visible to an observer, and
wherein when the first or second edge portions are in a partially torn or torn state, the outer threads are visible and at least a portion of the inner threads are visible to the observer.

15. The fall protection system of claim 8, wherein the retraction device is structured to grip the lifeline in response to a user of the fall protection system falling.
